(19) United States
(12) Patent Application Publication
(10) Pub. No.: US 2025/0311068 A1
(43) Pub. Date: Oct. 2, 2025

(54) SYSTEMS AND METHODS FOR CONTROLLING ELECTRIC COOKING APPARATUSES USING SENSORS

(71) Applicant: Tammy Karen Clark, Chatham, VA (US)

(72) Inventor: Tammy Karen Clark, Chatham, VA (US)

(21) Appl. No.: 19/097,227

(22) Filed: Apr. 1, 2025

Related U.S. Application Data
(60) Provisional application No. 63/573,128, filed on Apr. 2, 2024.

(51) Int. Cl. H05B 6/66; H05B 1/02; H05B 6/64

(52) U.S. Cl. CPC H05B 6/666; H05B 1/0263; H05B 6/645; H05B 6/6461

(57) ABSTRACT

A device for controlling an electric cooking apparatus, may include one or more processors, memory, and one or more sensors including a carbon monoxide sensor. The one or more processors may determine, based on at least one of an electric signal output from the cooking apparatus or an electric signal output from the one or more sensors, whether the cooking apparatus performs an operation. In response to determining that the cooking apparatus performs an operation, the one or more processors may cause the carbon monoxide sensor to measure a level of carbon monoxide. The one or more processors may determine whether the level of carbon monoxide exceeds a first threshold. In response to determining that the level of carbon monoxide exceeds the first threshold, the one or more processors may control the cooking apparatus to stop performing the operation.

### CROSS-REFERENCE TO RELATED APPLICATIONS

This application claims priority to U.S. Provisional Application 63/573,128, filed Apr. 2, 2024, the entire contents of which are incorporated herein by reference.

### TECHNICAL FIELD

The present disclosure relates to systems and methods for controlling electric apparatus and more particularly to systems and methods for controlling or stopping cooking operations of an electric cooking apparatus based on outputs of one or more sensors.

### BACKGROUND

Microwave and oven fires are commonly caused by overheated items like aluminum foil or food packaging. Electrical issues can also lead to fires, including power surges and shorted-out power supply units. If a fire occurs, there is a need to extinguish the fire immediately before it spreads to other areas of the home and causes significant damage.

### SUMMARY

Implementations of the present disclosure relate to a system and a method for controlling electric apparatus and more particularly to systems and methods for controlling or stopping cooking operations of an electric cooking apparatus based on outputs of one or more sensors.

In some implementations of the present disclosure, a device for controlling an electric cooking apparatus, may include one or more processors, memory, and one or more sensors including a carbon monoxide sensor. The one or more processors may be configured to determine, based on at least one of an electric signal output from the cooking apparatus or an electric signal output from the one or more sensors, whether the cooking apparatus performs an operation. In response to determining that the cooking apparatus performs an operation, the one or more processors may be configured to cause the carbon monoxide sensor to measure a level of carbon monoxide. The one or more processors may be configured to determine whether the level of carbon monoxide exceeds a first threshold. In response to determining that the level of carbon monoxide exceeds the first threshold, the one or more processors may be configured to control the cooking apparatus to stop performing the operation.

In some implementations of the present disclosure, a method for controlling notifications relating to one or more autistic patients, may include determining, by one or more processors based on at least one of an electric signal output from the cooking apparatus or an electric signal output from one or more sensors, whether the cooking apparatus performs an operation. The method may include in response to determining that the cooking apparatus performs an operation, causing, by the one or more processors, a carbon monoxide sensor of the one or more sensors to measure a level of carbon monoxide. The method may include determining, by the one or more processors, whether the level of carbon monoxide exceeds a first threshold. The method may include in response to determining that the level of carbon monoxide exceeds the first threshold, controlling, by the one or more processors, the cooking apparatus to stop performing the operation.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1A and FIG. 1B are block diagrams illustrating example cooking apparatus controlling systems, according to some implementations.

FIG. 2 is a block diagram illustrating an example of a computing system, according to some implementations.

FIG. 3 is a flowchart illustrating an example methodology for controlling or stopping cooking operations of an electric cooking apparatus based on outputs of one or more sensors, according to some implementations.

### DETAILED DESCRIPTION

According to certain aspects, implementations in the present disclosure relate to a system and a method for controlling or stopping cooking operations of an electric cooking apparatus based on outputs of one or more sensors.

Microwave and oven fires are commonly caused by overheated items like aluminum foil or food packaging. Electrical issues can also lead to fires, including power surges and shorted-out power supply units. If a fire occurs, there is a need to extinguish the fire immediately before it spreads to other areas of the home and causes significant damage.

To solve the above-noted problems, according to certain aspects, a system (e.g., cooking apparatus controlling system) can provide users with a device (e.g., cooking apparatus controlling device, kill switch, emergency off (EMO) switch, emergency power off (EPO) device) that can automatically stop a cooking operation or shut off power to an electric cooking apparatus (e.g., a microwave or oven) when smoke or carbon monoxide is detected. Examples of the electric cooking apparatus may include an electric stove or range, an electric oven, a microwave oven, an electric kettle, a toaster and/or toaster oven, a blender or food processor, an electric grill or griddle, an electric pressure cooker, a slow cooker, or specialized cookware for electric stoves, or the like. For example, the system can control a smoke-activated shut-off switch for microwave ovens to provide a safety system for microwave ovens designed to immediately kill power if smoke and/or carbon monoxide is detected. The system can utilize one or more sensors to detect smoke and/or dangerous particles in the air to then instantly shut off appliance power to prevent fires. In this manner, the system can prevent fire and loss of property due to fires on electric cooking apparatuses, and can offer a safe cooking experience without worry or concern for homeowners, restaurants, and the like.

In some implementations, the system can provide a smoke-activated control device (or shut-off switch device) for an electric cooking apparatus (e.g., a microwave oven or an oven). In some implementations, the control device may include a smoke and/or carbon monoxide (CO) kill switch. In some implementations, the control device may include one or more sensors (or detectors) configured to detect smoke and/or CO. In some implementations, the control device may include a detector that can cut off (e.g., shut off, turn off, disconnect) power to a microwave or oven when a predefined amount of CO and/or a predefined amount of smoke are detected. In some implementations, the one or more sensors (or detectors) may include at least one of a CO sensor, an electromagnetic field (EMF) detector, a temperature sensor (attached to a surface of the electric cooking apparatus), a smoke detector, one or more toxic gas detectors, a smoke detector, or a combination thereof.

In some implementations, the CO sensor may include at least one of an electrochemical Sensor, a metal oxide sensor, a biomimetic sensor, an infrared sensor, or any sensor/detector that can detect the presence of the carbon monoxide (CO) gas to prevent carbon monoxide poisoning. In some implementations, the electromagnetic field (EMF) detector may include at least one of a broadband probe EMF detector, frequency selective EMF detector, a single-axis EMF meter, a tri-axis EMF meter, an active EMF detector, a passive EMF detector, or any sensor/detector that can measure ambient (surrounding) electromagnetic fields.

In some implementations, the one or more toxic gas detectors may include at least one of an electrochemical sensor, a metal oxide semiconductor, an infrared detector, a photoionization detector (PID), an ultrasonic detector, a tunable diode laser spectroscopy (TDLAS), a colorimetric gas detection tube, an open path detector, or any sensor/detector that can detect one or more tox gases (e.g., nitrogen oxides, hydrogen cyanide, hydrogen chloride, or nitrogen dioxide). In some implementations, the smoke detector may include at least one of an ionization smoke detector, a photoelectric smoke detector, a combination smoke detector (e.g., combination of ionization and photoelectric technologies), or any sensor/detector that can sense smoke, typically as an indicator of fire.

In some implementations, the control device may be housed in a case/housing. In some implementations, the control device may be outside of a cooking apparatus, for example, connected between a power supply and the cooking apparatus. In some implementations, the control device may be integrated/embedded/disposed within a cooking apparatus. In some implementations, the control device may include one or more processors, one or more sensors/detectors, a shut-off switch, and/or other circuitry (e.g., one or more wires, one or more transistors, a voltage divider circuit, and a circuit board). Exact size, measurement, construction, design and specifications of the control device may vary upon the size, construction, design and specifications of the cooking apparatus. In some implementations, the control device may receive one or more outputs from the one or more sensors/detectors, and determine, based on the one or more outputs, whether a level of detected CO exceeds a CO threshold, and/or whether a level of detected smoke exceeds a smoke threshold. In response to determining that the level of detected CO exceeds the CO threshold, and/or that the level of detected smoke exceeds the smoke threshold, the control device may generate, using a voltage divider circuit, a voltage signal to shut off (e.g., open, turn off, disconnect) a switch (or activate a shut-off switch) so that the power source is disconnected from the cooking apparatus.

In some implementations, the (shut-off) switch of the control device may include at least one of a disconnect switch, a safety switch, a kill switch, an emergency stop, a battery disconnect switch, a fusible disconnect switch, or a non-fusible disconnect switch.

In some implementations, CO detectors can safeguard against a silent threat of carbon monoxide poisoning (e.g., due to overheated items like aluminum foil or food packaging) while smoke detectors can safeguard against fire or combustion of materials which normally produces smoke. Therefore, the system can utilize both CO detectors and smoke detectors to distinguish the source/cause of threat between overheated items and combustions of other materials (e.g., fire due to electrical issues). For example, if a CO level detected by a CO detector exceeds a significant CO level (e.g., a threshold of CO level), the system may determine that the cause of threat may be overheated items and may stop the cooking operation of a cooking apparatus (e.g., stop a microwave operation in a microwave or turn off a heating element in an electric cooktop) instead of shutting off electric power to the cooking apparatus. On the other hand, if a CO level detected by a CO detector does not exceed a significant CO level (e.g., a threshold of CO level) but a level of smoke detected by a smoke detector exceeds a significant level (e.g. a threshold of smoke level), the system may determine that the cause of threat is an electrical issue instead of overheated items. In this case, the system can shut off electric power to the cooking apparatus instead of just stopping the cooking operation.

According to certain aspects, implementations in the present disclosure relate to a method and a system for controlling notifications relating to one or more autistic patients. The system may include one or more processors and memory. The one or more processors may be configured to determine, based on at least one of an electric signal output from the cooking apparatus or an electric signal output from the one or more sensors, whether the cooking apparatus performs an operation. In response to determining that the cooking apparatus performs an operation, the one or more processors may be configured to cause the carbon monoxide sensor to measure a level of carbon monoxide. The one or more processors may be configured to determine whether the level of carbon monoxide exceeds a first threshold. In some implementations, the first threshold may refer to a level of carbon monoxide (CO) and can be determined based on CO levels that can cause a health problem of a person. For example, the first threshold may be greater than or equal to 70 ppm which correspond to CO levels that may cause an increase in chest pain. In some implementations, the first threshold may be greater than or equal to 150 ppm which correspond to CO levels that may cause disorientation, unconsciousness and/or possibly death. In some implementations, the first threshold may be greater than or equal to 200 ppm.

In response to determining that the level of carbon monoxide exceeds the first threshold, the one or more processors may be configured to control the cooking apparatus to stop performing the operation.

In some implementations, the one or more processors may be configured to control a power supply of the cooking apparatus. In controlling the cooking apparatus to stop performing the operation, the one or more processors may be configured to disconnect the power supply from the cooking apparatus.

In some implementations, the one or more sensors may include an electromagnetic field detector. The cooking device may be a microwave oven. In determining whether the cooking apparatus performs an operation, the one or more processors may be configured to cause the electromagnetic field detector to measure an intensity of an electromagnetic field. In response to determining that the measured intensity of the electromagnetic field is greater than or equal to a second threshold, the one or more processors may be configured to determine that the cooking apparatus performs the operation. In some implementations, the second threshold can be expressed as electric field strength in unit of V/m. The second threshold may be set depending on the type, size and specification of the electric cooking apparatus, or a distance from the electromagnetic field detector to the electric cooking apparatus. For example, for microwave ovens, the second threshold may be greater than or equal to 10 V/m, or if the distance from the electromagnetic field detector to the electric cooking apparatus is relatively short (e.g., 5 cm), the second threshold may be greater than or equal to 50 V/m.

In some implementations, the one or more sensors may include a temperature sensor. In determining whether the cooking apparatus performs an operation, the one or more processors may be configured to cause the temperature sensor to measure a temperature of the cooking apparatus. In response to determining that the measured temperature of the cooking apparatus is greater than or equal to a third threshold, the one or more processors may be configured determine that the cooking apparatus performs the operation. In some implementations, the temperature sensor (or the control device) may be positioned/installed close to the cooking apparatus (e.g., 5 cm to 1 m). In some implementations, the temperature sensor (or the control device) may be attached to the cooking apparatus. The third threshold may be set depending on the type, size and specification of the electric cooking apparatus, ambient (surrounding) temperature of heating elements of the electric cooking apparatus (when in operation), or a distance from the temperature sensor to the electric cooking apparatus (e.g., distance from the temperature sensor to heating elements of the electric cooking apparatus). The heating elements of the electric cooking apparatus may include at least one of gas burners, electric coils, smooth-top surfaces, radiant heating elements, or induction cooktops, or cooking cavity of microwave ovens. The third threshold may be greater than or equal to 58° C. which is a temperature point as commonly used in heat detectors. If the distance from the temperature sensor to the electric cooking apparatus is relatively short (e.g., 5 cm), the third threshold may be greater than or equal to 90° C.

In some implementations, the one or more sensors may include a smoke detector. In response to determining that the level of carbon monoxide does not exceed the first threshold, the one or more processors may be configured to cause the smoke detector to determine whether smoke particles are present. In response to determining the presence of smoke particles, the one or more processors may be configured to control the cooking apparatus to stop performing the operation.

In some implementations, the one or more sensors may include one or more toxic gas detectors. In response to determining that the level of carbon monoxide does not exceed the first threshold, the one or more processors may be configured to cause the one or more toxic gas detectors to detect whether one or more toxic gases are present. In response to determining the presence of the one or more toxic gases, the one or more processors may be configured to control the cooking apparatus to stop performing the operation. The one or more toxic gases may include at least one of nitrogen oxides, hydrogen cyanide, hydrogen chloride, or nitrogen dioxide.

In some implementations, the cooking apparatus may include a controller configured to control operations of the cooking apparatus. The one or more processors may be configured to control a power supply of the cooking apparatus, and control the controller of the cooking apparatus. In determining whether the cooking apparatus performs an operation, the one or more processors may be configured to determine, based on an electric signal output from the controller, whether the cooking apparatus performs the operation. In controlling the cooking apparatus to stop performing the operation, the one or more processors may be configured to cause the controller to stop performing the operation.

In some implementations, the one or more sensors may include a smoke detector. In response to determining that the level of carbon monoxide does not exceed the first threshold, the one or more processors may be configured to cause the smoke detector to determine whether smoke particles are present. In response to determining the presence of smoke particles, the one or more processors may be configured to disconnect the power supply from the cooking apparatus.

In some implementations, the one or more sensors may include one or more toxic gas detectors. In response to determining that the level of carbon monoxide does not exceed the first threshold, the one or more processors may be configured to cause the one or more toxic gas detectors to determine whether one or more toxic gases are presence. In response to determining the presence of the one or more toxic gases, the one or more processors may be configured to disconnect the power supply from the cooking apparatus.

Various implementations in the present disclosure have one or more of the following advantages and benefits. First, implementations in the present disclosure can provide users with a kill switch that will automatically shut off power to a microwave or oven when smoke or carbon monoxide is detected, thereby preventing fire and loss of property due to microwave or oven fires, and offering a safe cooking experience without worry or concern for homeowners, restaurants, and more.

Second, implementations in the present disclosure can utilize both CO detectors and smoke detectors to distinguish the source/cause of threat between overheated items and combustions of other materials (e.g., fire due to electrical issues). For example, if a CO level detected by a CO detector does not exceed a significant CO level (e.g., a threshold of CO level) but a level of smoke detected by a smoke detector exceeds a significant level (e.g. a threshold of smoke level), the system can determine that the cause of threat is an electrical issue instead of overheated items, and shut off electric power to the cooking apparatus instead of just stopping the cooking operation.

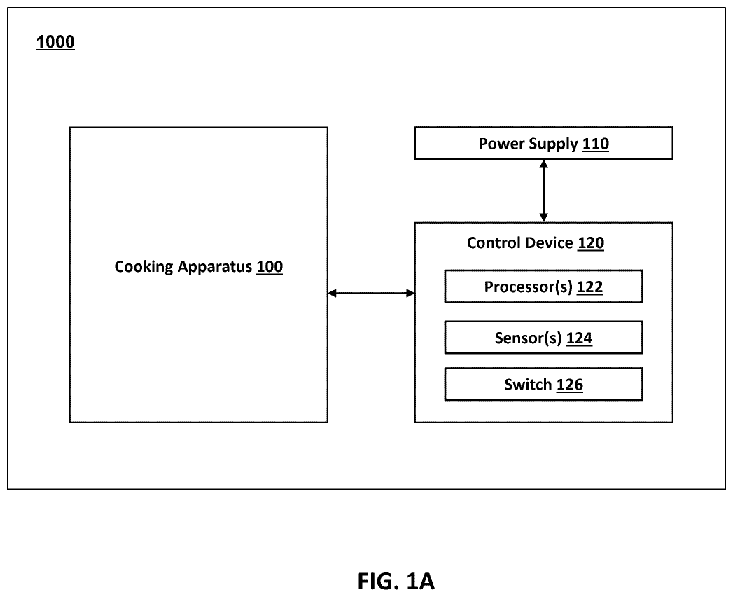

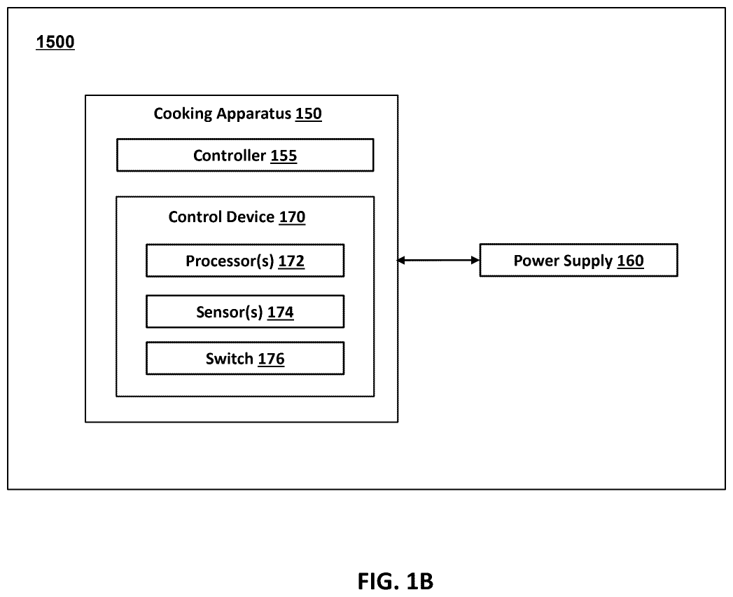

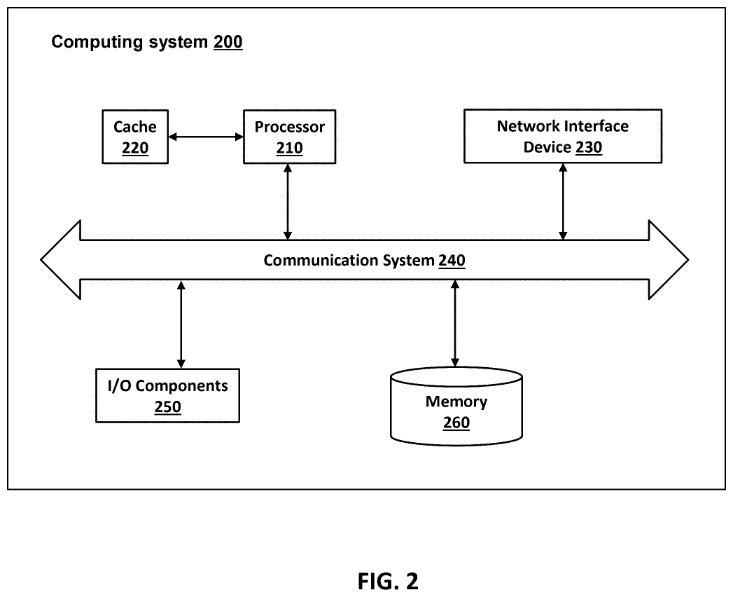

FIG. 1A and FIG. 1B are block diagrams illustrating example cooking apparatus controlling systems, according to some implementations. Referring to FIG. 1A, a cooking apparatus controlling system 1000 may include an electric cooking apparatus 100, a control device 120, and a power supply 110 (for the cooking apparatus 100). The control device 120 may be coupled to both the cooking apparatus 100 and the power supply 110 such that the control device 120 is connected between the power supply 110 and the cooking apparatus 100. The control device 120 may be located/positioned close to (e.g., 5 cm to 1 m) the cooking apparatus 100. The control device 120 may be attached to a surface of the cooking apparatus 100 (e.g., close to heating elements of the cooking apparatus 100). The heating elements (not shown) of the electric cooking apparatus 100 may include at least one of gas burners, electric coils, smooth-top surfaces, radiant heating elements, or induction cooktops, or cooking cavity of microwave ovens. The control device 120 may be housed in a case/housing (not shown). The control device 120 may be outside of the cooking apparatus 100, for example, connected between the power supply 110 and the cooking apparatus 100. Exact size, measurement, construction, design and specifications of the control device 120 may vary upon the size, construction, design and specifications of the cooking apparatus 100. In some implementations, the control device 120 may include one or more processors 122, one or more sensors/detectors 124, a shut-off switch 126, and/or other circuitry (e.g., one or more wires, one or more transistors, a voltage divider circuit, and a circuit board). The control device 120 may have a configuration similar to that of the computing system 200 in FIG. 2. For example, the one or more processors 122 may have a configuration similar to that of the one or more processors 210 in FIG. 2.

In some implementations, the control device 120 may receive one or more outputs from the one or more sensors/detectors 124 including a CO sensor/detector and at least one of a smoke detector, a temperature detector, or an electromagnetic field detector. The control device 120 may determine, based on the one or more outputs, whether a level of detected CO exceeds a CO threshold, and/or whether a level of detected smoke exceeds a smoke threshold. In response to determining that the level of detected CO exceeds the CO threshold, and/or that the level of detected smoke exceeds the smoke threshold, the control device 120 may generate, using a voltage divider circuit, a voltage signal to shut off (e.g., open, turn off, disconnect) the switch 126 (or activate the shut-off switch 126) so that the power source 110 is disconnected from the cooking apparatus 100. The (shut-off) switch 126 of the control device 120 may include at least one of a disconnect switch, a safety switch, a kill switch, an emergency stop, a battery disconnect switch, a fusible disconnect switch, or a non-fusible disconnect switch.

Referring to FIG. 1A, the one or more processors 120 may be configured to determine, based on an electric signal output from the one or more sensors 124 (e.g., a temperature detector or an electromagnetic field detector), whether the cooking apparatus performs an operation. In response to determining that the cooking apparatus 100 performs an operation, the one or more processors 122 may be configured to cause the carbon monoxide sensor to measure a level of carbon monoxide. The one or more processors 122 may be configured to determine whether the level of CO exceeds a first threshold. In some implementations, the first threshold may refer to a level of CO and can be determined based on CO levels that can cause a health problem of a person. For example, the first threshold may be greater than or equal to 70 ppm which correspond to CO levels that may cause an increase in chest pain. In some implementations, the first threshold may be greater than or equal to 150 ppm which correspond to CO levels that may cause disorientation, unconsciousness and/or possibly death. In some implementations, the first threshold may be greater than or equal to 200 ppm.

In response to determining that the level of CO exceeds the first threshold, the one or more processors 122 may be configured to control the cooking apparatus 100 to stop performing the operation by disconnecting the power supply 110 from the cooking apparatus 100.

The one or more sensors 124 may include an electromagnetic field detector. The cooking device 100 may be a microwave oven. In determining whether the cooking apparatus 100 performs an operation, the one or more processors 122 may be configured to cause the electromagnetic field detector to measure an intensity of an electromagnetic field. In response to determining that the measured intensity of the electromagnetic field is greater than or equal to a second threshold, the one or more processors 122 may be configured to determine that the cooking apparatus 100 performs the operation. The second threshold can be expressed as electric field strength in unit of V/m. The second threshold may be set depending on the type, size and specification of the electric cooking apparatus 100, or a distance from the electromagnetic field detector to the electric cooking apparatus 100. For example, for microwave ovens, the second threshold may be greater than or equal to 10 V/m, or if the distance from the electromagnetic field detector to the electric cooking apparatus 100 is relatively short (e.g., 5 cm), the second threshold may be greater than or equal to 50 V/m.

The one or more sensors 124 may include a temperature sensor. In determining whether the cooking apparatus 100 performs an operation, the one or more processors 122 may be configured to cause the temperature sensor to measure a temperature of the cooking apparatus 100. In response to determining that the measured temperature of the cooking apparatus 100 is greater than or equal to a third threshold, the one or more processors 122 may be configured determine that the cooking apparatus 100 performs the operation. The temperature sensor (or the control device 120) may be positioned/installed close to the cooking apparatus 100 (e.g., 5 cm to 1 m). In some implementations, the temperature sensor (or the control device 120) may be attached to the cooking apparatus 100. The third threshold may be set depending on the type, size and specification of the electric cooking apparatus 100, ambient (surrounding) temperature of heating elements of the electric cooking apparatus 100 (when in operation), or a distance from the temperature sensor to the electric cooking apparatus 100 (e.g., distance from the temperature sensor to heating elements of the electric cooking apparatus 100). The third threshold may be greater than or equal to 58° C. which is a temperature point as commonly used in heat detectors. If the distance from the temperature sensor to the electric cooking apparatus 100 is relatively short (e.g., 5 cm), the third threshold may be greater than or equal to 90° C.

The one or more sensors 124 may include a smoke detector. In response to determining that the level of carbon monoxide does not exceed the first threshold, the one or more processors 122 may be configured to cause the smoke detector to determine whether smoke particles are present. In response to determining the presence of smoke particles, the one or more processors 122 may be configured to control the cooking apparatus 100 to stop performing the operation by disconnecting the power supply 110 from the cooking apparatus 100.

The one or more sensors 124 may include one or more toxic gas detectors. In response to determining that the level of carbon monoxide does not exceed the first threshold, the one or more processors 122 may be configured to cause the one or more toxic gas detectors to detect whether one or more toxic gases are present. In response to determining the presence of the one or more toxic gases, the one or more processors 122 may be configured to control the cooking apparatus 100 to stop performing the operation by disconnecting the power supply 110 from the cooking apparatus 100. The one or more toxic gases may include at least one of nitrogen oxides, hydrogen cyanide, hydrogen chloride, or nitrogen dioxide.

Referring to FIG. 1B, a cooking apparatus controlling system 1500 may include an electric cooking apparatus 150 and a power supply 160 (for the cooking apparatus 150). The control device 170 may be embedded/integrated/disposed within the cooking apparatus 150. The cooking apparatus 150 may include a controller 155 configured to control operations of the cooking apparatus 150. In some implementations, the control device 170 may include one or more processors 172, one or more sensors/detectors 174, a shut-off switch 176, and/or other circuitry (e.g., one or more wires, one or more transistors, a voltage divider circuit, and a circuit board). In some implementations, the control device 170 may have a configuration similar to that of the computing system 200 in FIG. 2. For example, the one or more processors 172 may have a configuration similar to that of the one or more processors 210 in FIG. 2. In some implementations, the one or more processors 172 may be integrated/combined with the controller 155.

Referring to FIG. 1B, the one or more processors 120 may be configured to determine, based on at least one of an electric signal output from the cooking apparatus or an electric signal output from the one or more sensors, whether the cooking apparatus performs an operation. In response to determining that the cooking apparatus performs an operation, the one or more processors may be configured to cause the carbon monoxide sensor to measure a level of carbon monoxide. The one or more processors may be configured to determine whether the level of carbon monoxide exceeds a first threshold. In some implementations, the first threshold may refer to a level of carbon monoxide (CO) and can be determined based on CO levels that can cause a health problem of a person. For example, the first threshold may be greater than or equal to 70 ppm which correspond to CO levels that may cause an increase in chest pain. In some implementations, the first threshold may be greater than or equal to 150 ppm which correspond to CO levels that may cause disorientation, unconsciousness and/or possibly death. In some implementations, the first threshold may be greater than or equal to 200 ppm.

In some implementations, the control device 170 may receive one or more outputs from the one or more sensors/detectors 174 including a CO detector and a smoke detector. The control device 170 may determine, based on the one or more outputs, whether a level of detected CO exceeds a CO threshold, and/or whether a level of detected smoke exceeds a smoke threshold. In response to determining that the level of detected CO exceeds the CO threshold, and/or that the level of detected smoke exceeds the smoke threshold, the control device 170 may generate, using a voltage divider circuit, a voltage signal to shut off (e.g., open, turn off, disconnect) the switch 176 (or activate the shut-off switch 176) so that the power source 160 is disconnected from the cooking apparatus 150. The (shut-off) switch 176 of the control device 170 may include at least one of a disconnect switch, a safety switch, a kill switch, an emergency stop, a battery disconnect switch, a fusible disconnect switch, or a non-fusible disconnect switch.

The controller 155 may be configured to control operations of the cooking apparatus 150. The one or more processors 172 (of the control device 170) may be configured to control the power supply 160 of the cooking apparatus 150, and control the controller 155 of the cooking apparatus 150. In determining whether the cooking apparatus 150 performs an operation (e.g., a heating operation), the one or more processors may be configured to determine, based on an electric signal output from the controller 155, whether the cooking apparatus 150 performs the operation. In controlling the cooking apparatus 150 to stop performing the operation, the one or more processors 172 may be configured to cause the controller 155 to stop performing the operation. For example, in a microwave oven, in response to determining that the cooking apparatus 150 performs a microwave heating operation, the one or more processors 172 may be configured to cause the controller 155 to stop performing the microwave heating operation without disconnecting the power supply 160 from the cooking apparatus 150.

In response to determining that the cooking apparatus 150 performs an operation (e.g., heating operation), the one or more processors 172 may be configured to cause the carbon monoxide sensor to measure a level of carbon monoxide. The one or more processors 172 may be configured to determine whether the level of CO exceeds a first threshold. The first threshold may refer to a level of CO and can be determined based on CO levels that can cause a health problem of a person. For example, the first threshold may be greater than or equal to 70 ppm which correspond to CO levels that may cause an increase in chest pain. In some implementations, the first threshold may be greater than or equal to 150 ppm which correspond to CO levels that may cause disorientation, unconsciousness and/or possibly death. In some implementations, the first threshold may be greater than or equal to 200 ppm.

In response to determining that the level of carbon monoxide exceeds the first threshold, the one or more processors 172 may be configured to control the cooking apparatus 150 to stop performing the operation (e.g., by controlling the controller 155). In some implementations, in controlling the cooking apparatus 150 to stop performing the operation, the one or more processors 172 may be configured to disconnect the power supply 160 from the cooking apparatus 150.

The one or more sensors 174 may include a smoke detector. In response to determining that the level of CO does not exceed the first threshold, the one or more processors 172 may be configured to cause the smoke detector to determine whether smoke particles are present. In response to determining the presence of smoke particles, the one or more processors 172 may be configured to control the cooking apparatus 150 to stop performing the operation (e.g., stop performing a heating operation by controlling the controller 155 or disconnect the power supply 160 from the cooking apparatus 150).

The one or more sensors 174 may include one or more toxic gas detectors. In response to determining that the level of CO does not exceed the first threshold, the one or more processors 172 may be configured to cause the one or more toxic gas detectors to detect whether one or more toxic gases are present. In response to determining the presence of the one or more toxic gases, the one or more processors 172 may be configured to control the cooking apparatus 150 to stop performing the operation (e.g., stop performing a heating operation by controlling the controller 155 or disconnect the power supply 160 from the cooking apparatus 150). The one or more toxic gases may include at least one of nitrogen oxides, hydrogen cyanide, hydrogen chloride, or nitrogen dioxide.

The one or more sensors 174 may include a smoke detector. In response to determining that the level of CO does not exceed the first threshold, the one or more processors 172 may be configured to cause the smoke detector to determine whether smoke particles are present. In response to determining the presence of smoke particles, the one or more processors 172 may be configured to disconnect the power supply from the cooking apparatus (instead of controlling the controller 155 to stop a heating operation).

The one or more sensors 174 may include one or more toxic gas detectors. In response to determining that the level of carbon monoxide does not exceed the first threshold, the one or more processors 172 may be configured to cause the one or more toxic gas detectors to determine whether one or more toxic gases are presence. In response to determining the presence of the one or more toxic gases, the one or more processors 172 may be configured to disconnect the power supply 160 from the cooking apparatus 150 (instead of controlling the controller 155 to stop a heating operation).

FIG. 2 is a block diagram illustrating an example of a computing system according to some implementations.

Referring to FIG. 2, the illustrated example computing system 200 includes one or more processors 210 in communication, via a communication system 240 (e.g., bus), with memory 260, at least one network interface controller 230 with network interface port for connection to a network (not shown), and other components, e.g., an input/output (“I/O”) components interface 450 connecting to a display (not illustrated) and an input device (not illustrated). Generally, the processor(s) 210 will execute instructions (or computer programs) received from memory. The processor(s) 210 illustrated incorporate, or are directly connected to, cache memory 220. In some instances, instructions are read from memory 260 into the cache memory 220 and executed by the processor(s) 210 from the cache memory 220.

In more detail, the processor(s) 210 may be any logic circuitry that processes instructions, e.g., instructions fetched from the memory 260 or cache 220. In some implementations, the processor(s) 210 are microprocessor units or special purpose processors. The computing device 200 may be based on any processor, or set of processors, capable of operating as described herein. The processor(s) 210 may be single core or multi-core processor(s). The processor(s) 210 may be multiple distinct processors.

The memory 260 may be any device suitable for storing computer readable data. The memory 260 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 200 may have any number of memory devices as the memory 260.

The cache memory 220 is generally a form of computer memory placed in close proximity to the processor(s) 210 for fast read times. In some implementations, the cache memory 220 is part of, or on the same chip as, the processor(s) 210. In some implementations, there are multiple levels of cache 220, e.g., L2 and L3 cache layers.

The network interface controller 230 manages data exchanges via the network interface (sometimes referred to as network interface ports). The network interface controller 230 handles the physical and data link layers of the OSI model for network communication. In some implementations, some of the network interface controller's tasks are handled by one or more of the processor(s) 210. In some implementations, the network interface controller 230 is part of a processor 210. In some implementations, a computing system 200 has multiple network interfaces controlled by a single controller 230. In some implementations, a computing system 200 has multiple network interface controllers 230. In some implementations, each network interface is a connection point for a physical network link (e.g., a cat-5 Ethernet link). In some implementations, the network interface controller 230 supports wireless network connections and an interface port is a wireless (e.g., radio) receiver/transmitter (e.g., for any of the IEEE 802.11 protocols, near field communication “NFC”, Bluetooth, ANT, or any other wireless protocol). In some implementations, the network interface controller 230 implements one or more network protocols such as Ethernet. Generally, a computing device 200 exchanges data with other computing devices via physical or wireless links through a network interface. The network interface may link directly to another device or to another device via an intermediary device, e.g., a network device such as a hub, a bridge, a switch, or a router, connecting the computing device 200 to a data network such as the Internet.

The computing system 200 may include, or provide interfaces for, one or more input or output (“I/O”) devices 250. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

Other components may include an I/O interface, external serial device ports, and any additional co-processors. For example, a computing system 200 may include an interface (e.g., a universal serial bus (USB) interface) for connecting input devices, output devices, or additional memory devices (e.g., portable flash drive or external media drive). In some implementations, a computing device 200 includes an additional device such as a co-processor, e.g., a math co-processor can assist the processor 210 with high precision or complex calculations.

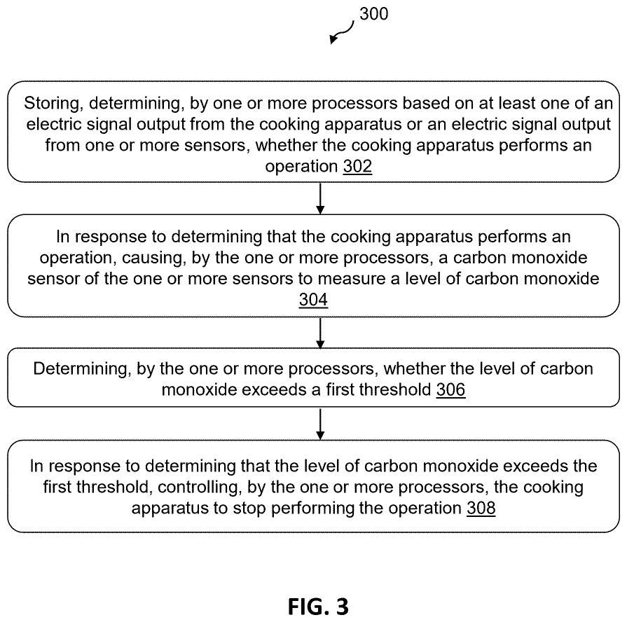

FIG. 3 is a flowchart illustrating an example methodology for controlling or stopping cooking operations of an electric cooking apparatus based on outputs of one or more sensors, according to some implementations. In some embodiments, the process 300 is performed by one or more processors (e.g. one or more processors 122 of control device 120, or one or more processors 172 of control device 170). In other embodiments, the process 300 is performed by other entities. In some embodiments, the process 300 includes more, fewer, or different steps than shown in FIG. 3.

In this example methodology, the process 300 begins at step 302 by determining, by one or more processors (e.g. one or more processors 122 of control device 120, or one or more processors 172 of control device 170) based on at least one of an electric signal output from the cooking apparatus (e.g., an electric signal output from the controller 155) or an electric signal output from one or more sensors (e.g., an electric signal output from an electromagnetic field detector or a temperature detector), whether the cooking apparatus performs an operation.

In some implementations, the one or more sensors (e.g., sensors 124) may include an electromagnetic field detector. The cooking device (e.g., cooking device 100) may be a microwave oven. In determining whether the cooking apparatus performs an operation (e.g., microwave heating operation), the device (e.g., control device 120) may cause the electromagnetic field detector to measure an intensity of an electromagnetic field. In response to determining that the measured intensity of the electromagnetic field is greater than or equal to a second threshold (e.g., 10 V/m), the device (e.g., control device 120) may determine that the cooking apparatus performs the operation.

In some implementations, the one or more sensors (e.g., sensors 124) may include a temperature sensor. In determining whether the cooking apparatus (e.g., cooking device 100) performs an operation (e.g., a heating operation by a heating element of the cooking device), the device (e.g., control device 120) may cause the temperature sensor to measure a temperature of the cooking apparatus. In response to determining that the measured temperature of the cooking apparatus is greater than or equal to a third threshold (e.g., 90° C.), the device may determine that the cooking apparatus performs the operation.

In some implementations, the cooking apparatus (e.g., cooking apparatus 150) may include a controller (e.g., controller 155) configured to control operations (e.g., heating operation) of the cooking apparatus. The device (e.g., control device 170) may control a power supply of the cooking apparatus. The device may control the controller (e.g., controller 155) of the cooking apparatus. In determining whether the cooking apparatus (e.g., cooking apparatus 150) performs an operation (e.g., heating operation), the device (e.g., control device 170) may determine, based on an electric signal output from the controller (e.g., controller 155), whether the cooking apparatus performs the operation.

At step 304, in some implementations, in response to determining that the cooking apparatus performs an operation, the one or more processors may causing, by the one or more processors, a carbon monoxide sensor of the one or more sensors to measure a level of carbon monoxide. At step 306, in some implementations, the one or more processors may determine whether the level of carbon monoxide exceeds a first threshold (e.g., 70 ppm).

At step 308, in some implementations, in response to determining that the level of carbon monoxide exceeds the first threshold, the one or more processors may control the cooking apparatus to stop performing the operation (e.g., either stopping a heating operation or disconnecting the power supply from the cooking apparatus). In some implementations, the device may control a power supply of the cooking apparatus. In controlling the cooking apparatus to stop performing the operation, the device may disconnect the power supply from the cooking apparatus (e.g., using the switch 126, 176). In some implementations, in controlling the cooking apparatus (e.g., cooking apparatus 150) to stop performing the operation, the device (e.g., control device 170) may cause the controller (e.g., controller 155) to stop performing the operation (e.g., stop a heating operation of a heating element without disconnecting the power supply from the cooking apparatus).

In some implementations, the one or more sensors (e.g., sensors 124) may include a smoke detector. In response to determining that the level of carbon monoxide does not exceed the first threshold (e.g., 70 ppm), the device (e.g., control device 120) may cause the smoke detector to determine whether smoke particles are present. In response to determining the presence of smoke particles, the device (e.g., control device 120) may disconnect the power supply (e.g., power supply 110) from the cooking apparatus (e.g., cooking apparatus 100).

In some implementations, the one or more sensors (e.g., sensors 124) may include one or more toxic gas detectors. In response to determining that the level of carbon monoxide does not exceed the first threshold, the device (e.g., control device 120) may cause the one or more toxic gas detectors to determine whether one or more toxic gases are presence. In response to determining the presence of the one or more toxic gases, the device (e.g., control device 120) may disconnect the power supply (e.g., power supply 110) from the cooking apparatus (e.g., cooking apparatus 100).

In some implementations, the one or more sensors (e.g., sensors 174) may include a smoke detector. In response to determining that the level of carbon monoxide does not exceed the first threshold (e.g., 70 ppm), the device (e.g., control device 170) may cause the smoke detector to determine whether smoke particles are present. In response to determining the presence of smoke particles, the device (e.g., control device 170) may control the cooking apparatus (e.g., cooking apparatus 150) to stop performing the operation (e.g., by controlling the controller 155 to stop a heating operation without disconnecting the power supply from the cooking apparatus).

In some implementations, the one or more sensors (e.g., sensors 174) may include one or more toxic gas detectors. In response to determining that the level of carbon monoxide does not exceed the first threshold (e.g., 70 ppm), the device may cause the one or more toxic gas detectors to detect whether one or more toxic gases are present. In response to determining the presence of the one or more toxic gases, the device (e.g., control device 170) may control the cooking apparatus (e.g., cooking apparatus 150) to stop performing the operation (e.g., by controlling the controller 155 to stop a heating operation without disconnecting the power supply from the cooking apparatus). In some implementations, the one or more toxic gases may include at least one of nitrogen oxides, hydrogen cyanide, hydrogen chloride, or nitrogen dioxide.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the blocks of various examples must be performed in the order presented. As will be appreciated by one of skill in the art the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In some examples, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A device for controlling an electric cooking apparatus, comprising:
one or more processors and memory; and
one or more sensors including a carbon monoxide sensor,
wherein the one or more processors are configured to:
determine, based on at least one of an electric signal output from the cooking apparatus or an electric signal output from the one or more sensors, whether the cooking apparatus performs an operation;
in response to determining that the cooking apparatus performs an operation, cause the carbon monoxide sensor to measure a level of carbon monoxide;
determine whether the level of carbon monoxide exceeds a first threshold; and
in response to determining that the level of carbon monoxide exceeds the first threshold, control the cooking apparatus to stop performing the operation.

2. The device according to claim 1, wherein the one or more processors are configured to:
control a power supply of the cooking apparatus, and
in controlling the cooking apparatus to stop performing the operation, the one or more processors are configured to disconnect the power supply from the cooking apparatus.

3. The device according to claim 2, wherein
the one or more sensors comprise an electromagnetic field detector,
the cooking device is a microwave oven, and
in determining whether the cooking apparatus performs an operation, the one or more processors are configured to cause the electromagnetic field detector to measure an intensity of an electromagnetic field; and
in response to determining that the measured intensity of the electromagnetic field is greater than or equal to a second threshold, determine that the cooking apparatus performs the operation.

4. The device according to claim 2, wherein
the one or more sensors comprise a temperature sensor, and
in determining whether the cooking apparatus performs an operation, the one or more processors are configured to cause the temperature sensor to measure a temperature of the cooking apparatus; and
in response to determining that the measured temperature of the cooking apparatus is greater than or equal to a third threshold, determine that the cooking apparatus performs the operation.

5. The device according to claim 1, wherein
the one or more sensors comprise a smoke detector, and
the one or more processors are configured to:
in response to determining that the level of carbon monoxide does not exceed the first threshold, cause the smoke detector to determine whether smoke particles are present, and
in response to determining the presence of smoke particles, control the cooking apparatus to stop performing the operation.

6. The device according to claim 1, wherein
the one or more sensors comprise one or more toxic gas detectors, and
the one or more processors are configured to:
in response to determining that the level of carbon monoxide does not exceed the first threshold, cause the one or more toxic gas detectors to detect whether one or more toxic gases are present, and
in response to determining the presence of the one or more toxic gases, control the cooking apparatus to stop performing the operation.

7. The device according to claim 6, wherein the one or more toxic gases comprise at least one of nitrogen oxides, hydrogen cyanide, hydrogen chloride, or nitrogen dioxide.

8. The device according to claim 1, wherein
the cooking apparatus comprises a controller configured to control operations of the cooking apparatus, and
the one or more processors are configured to:
control a power supply of the cooking apparatus,
control the controller of the cooking apparatus,
in determining whether the cooking apparatus performs an operation, determine, based on an electric signal output from the controller, whether the cooking apparatus performs the operation, and
in controlling the cooking apparatus to stop performing the operation, cause the controller to stop performing the operation.

9. The device according to claim 8, wherein
the one or more sensors comprise a smoke detector, and
the one or more processors are configured to:
in response to determining that the level of carbon monoxide does not exceed the first threshold, cause the smoke detector to determine whether smoke particles are present, and
in response to determining the presence of smoke particles, disconnect the power supply from the cooking apparatus.

10. The device according to claim 8, wherein
the one or more sensors comprise one or more toxic gas detectors, and
the one or more processors are configured to:
in response to determining that the level of carbon monoxide does not exceed the first threshold, cause the one or more toxic gas detectors to determine whether one or more toxic gases are presence, and
in response to determining the presence of the one or more toxic gases, disconnect the power supply from the cooking apparatus.

11. A method for controlling an electric cooking apparatus, comprising:
determining, by one or more processors based on at least one of an electric signal output from the cooking apparatus or an electric signal output from one or more sensors, whether the cooking apparatus performs an operation;
in response to determining that the cooking apparatus performs an operation, causing, by the one or more processors, a carbon monoxide sensor of the one or more sensors to measure a level of carbon monoxide;
determining, by the one or more processors, whether the level of carbon monoxide exceeds a first threshold; and
in response to determining that the level of carbon monoxide exceeds the first threshold, controlling, by the one or more processors, the cooking apparatus to stop performing the operation.

12. The method according to claim 11, further comprising:
controlling a power supply of the cooking apparatus,
wherein controlling the cooking apparatus to stop performing the operation comprises disconnecting the power supply from the cooking apparatus.

13. The method according to claim 12, wherein
the one or more sensors comprise an electromagnetic field detector,
the cooking device is a microwave oven, and
determining whether the cooking apparatus performs an operation comprises:
causing the electromagnetic field detector to measure an intensity of an electromagnetic field; and
in response to determining that the measured intensity of the electromagnetic field is greater than or equal to a second threshold, determining that the cooking apparatus performs the operation.

14. The method according to claim 12, wherein
the one or more sensors comprise a temperature sensor, and
determining whether the cooking apparatus performs an operation comprises:
causing the temperature sensor to measure a temperature of the cooking apparatus; and
in response to determining that the measured temperature of the cooking apparatus is greater than or equal to a third threshold, determining that the cooking apparatus performs the operation.

15. The method according to claim 11, wherein
the one or more sensors comprise a smoke detector, and
the method further comprises:
in response to determining that the level of carbon monoxide does not exceed the first threshold, causing the smoke detector to determine whether smoke particles are present, and
in response to determining the presence of smoke particles, controlling the cooking apparatus to stop performing the operation.

16. The method according to claim 11, wherein
the one or more sensors comprise one or more toxic gas detectors, and
the method further comprises:
in response to determining that the level of carbon monoxide does not exceed the first threshold, causing the one or more toxic gas detectors to detect whether one or more toxic gases are present, and
in response to determining the presence of the one or more toxic gases, controlling the cooking apparatus to stop performing the operation.

17. The method according to claim 16, wherein the one or more toxic gases comprise at least one of nitrogen oxides, hydrogen cyanide, hydrogen chloride, or nitrogen dioxide.

18. The method according to claim 11, wherein
the cooking apparatus comprises a controller configured to control operations of the cooking apparatus, and
the method further comprises:
controlling a power supply of the cooking apparatus,
controlling the controller of the cooking apparatus,
determining whether the cooking apparatus performs an operation comprises determining, based on an electric signal output from the controller, whether the cooking apparatus performs the operation, and
controlling the cooking apparatus to stop performing the operation comprises causing the controller to stop performing the operation.

19. The method according to claim 18, wherein
the one or more sensors comprise a smoke detector, and
the method further comprises:
in response to determining that the level of carbon monoxide does not exceed the first threshold, causing the smoke detector to determine whether smoke particles are present, and
in response to determining the presence of smoke particles, disconnecting the power supply from the cooking apparatus.

20. The method according to claim 18, wherein
the one or more sensors include one or more toxic gas detectors, and
the method further comprises:
in response to determining that the level of carbon monoxide does not exceed the first threshold, causing the one or more toxic gas detectors to determine whether one or more toxic gases are presence, and
in response to determining the presence of the one or more toxic gases, disconnecting the power supply from the cooking apparatus.
